(19) United States
(12) Patent Application Publication
(10) Pub. No.: US 2020/0409601 A1
(43) Pub. Date: Dec. 31, 2020

(54) Hold of Write Commands in Zoned Namespaces

(71) Applicant: Western Digital Technologies, Inc., San Jose, CA (US)

(72) Inventors: Daniel L. HELMICK, Broomfield, CO (US); Peter GRAYSON, Grand Rapids, MI (US)

(21) Appl. No.: 16/696,830

(22) Filed: Nov. 26, 2019

Related U.S. Application Data
(60) Provisional application No. 62/868,792, filed on Jun. 28, 2019.

(51) Int. Cl. G06F 3/06

(52) U.S. Cl. CPC G06F 3/0659; G06F 3/0679; G06F 3/0604

(57) ABSTRACT

The present disclosure generally relates to methods of operating storage devices. A controller of the storage device retrieves data of a first command a first time and performs a first pass programming of the data of the first command to a first page in a first erase block. Data of a second command is then retrieved a first time by the controller, and the controller performs a first pass programming of the data of the second command to a second page in the first erase block. Upon retrieving the second command, the controller completes the processing of the first command by retrieving the data of the first command a second time and writing the data of the first command to the first page by performing a second pass programming. The data of the first command is stored in the host device until the second pass programming is complete.

### CROSS-REFERENCE TO RELATED APPLICATIONS

This application claims benefit of U.S. provisional patent application Ser. No. 62/868,792, filed Jun. 28, 2019, which is herein incorporated by reference.

### BACKGROUND OF THE DISCLOSURE

### Field of the Disclosure

Embodiments of the present disclosure generally relate to storage devices, such as sold state drives (SSDs).

### Description of the Related Art

Storage devices, such as SSDs, may be used in computers in applications where relatively low latency and high capacity storage are desired. For example, SSDs may exhibit lower latency, particularly for random reads and writes, than hard disk drives (HDDs). Typically, a controller of the SSD receives a command to read or write data from a host device. For write commands, the data associated with a command is then temporarily stored in an internal buffer or memory of the controller. Once the data associated with the command is stored in the internal memory of the controller, the controller sends a command completion entry to the host. Meanwhile, the data associated with the command is written to a media or memory device in the background. As such, the data is stored in the internal memory of the controller for the entire duration of the processing of the write command.

However, SSD controllers have a limited amount of internal memory that comes at both a power and cost impact to the SSDs. If the internal memory of the controller fills up completely, the controller may reduce the number of commands being worked in parallel or parse the commands without pulling-in the associated data. As such, temporarily storing the data associated with the command in the internal memory of the controller while the command completion entry is sent and while the data is written to the media negatively impacts the overall SSD performance, throughput, and efficiency, and increases the amount of power consumed while processing commands.

Thus, what is needed is a method of operating a storage device that decreases the amount of power consumed while increasing performance and throughput of the storage device.

### SUMMARY OF THE DISCLOSURE

The present disclosure generally relates to methods of operating storage devices. A controller of the storage device retrieves data of a first command a first time and performs a first pass programming of the data of the first command to a first page in a first erase block. Data of a second command is then retrieved a first time by the controller, and the controller performs a first pass programming of the data of the second command to a second page in the first erase block. Upon retrieving the second command, the controller completes the processing of the first command by retrieving the data of the first command a second time and writing the data of the first command to the first page by performing a second pass programming. The data of the first command is stored in the host device until the second pass programming is complete.

In one embodiment, a storage device comprises a media unit and a controller coupled to the media unit, wherein a capacity of the media unit is divided into a plurality of zones. The controller configured to retrieve a first command to write data to a first page in a first erase block of the media unit, the first erase block being disposed in a first zone of the plurality of zones, retrieve a second command to write data to a second page in the first erase block, and upon retrieving the second command, write the data associated with the first command to the first page in the first erase block.

In another embodiment, a storage device comprises a media unit. A capacity of the media unit is divided into a plurality of zones. The storage device further comprises a controller coupled to the media unit. The controller is configured to perform a first pass program of data associated with a first command to partially write the data to a first page in a first erase block of a first zone of the plurality of zones, perform the first pass program of data associated with a second command to partially write the data to a second page in the first erase block, upon performing the first pass program of the data associated with the second command, perform a second pass program to write the data associated with the first command to the first page in the first erase block.

In yet another embodiment, a storage device comprises a media unit, wherein a capacity of the media unit is divided into a plurality of zones, and a controller coupled to the media unit. The controller configured to retrieve a first command to write data to a first page in a first erase block of the storage device, the first erase block being disposed in a first zone of the plurality of zones, partially write the data associated with the first command to the first page in the first erase block at a first voltage target applied for a first amount of time, retrieve a second command to write data to a second page in the first erase block, partially write the data associated with the second command to the second page in the first erase block at the first voltage target, and upon retrieving the second command, write the data associated with the first command to the first page in the first erase block at a second voltage target applied for a second amount of time, the second amount of time being greater than the first amount of time.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system, according to one embodiment.

FIG. 2 illustrates a storage system comprising a storage device coupled to a host device, according to another embodiment.

FIG. 3 is a block diagram illustrating a method of operating a storage device to execute a read or write command, according to one embodiment.

FIG. 4A illustrates a Zoned Namespaces utilized in a storage device, according to one embodiment.

FIG. 4B illustrates a state diagram for the Zoned Namespaces of the storage device of FIG. 4A, according to one embodiment.

FIG. 5A illustrates a method for operating a storage device, according to one embodiment.

FIG. 5B illustrates an exemplary diagram demonstrating the expected voltage distribution for a first pass programming and a second pass programming as referred to in the method of FIG. 5A.

FIG. 6 illustrates a method for operating a storage device, according to another embodiment.

FIG. 7 illustrates a method of operating a storage device during a power fail, according to one embodiment.

FIG. 8 illustrates a method for operating a storage device not utilizing ZNS during a garbage collection process, according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to methods of operating storage devices. A controller of the storage device retrieves data of a first command a first time and performs a first pass programming of the data of the first command to a first page in a first erase block. Data of a second command is then retrieved a first time by the controller, and the controller performs a first pass programming of the data of the second command to a second page in the first erase block. Upon retrieving the second command, the controller completes the processing of the first command by retrieving the data of the first command a second time and writing the data of the first command to the first page by performing a second pass programming. The data of the first command is stored in the host device until the second pass programming is complete.

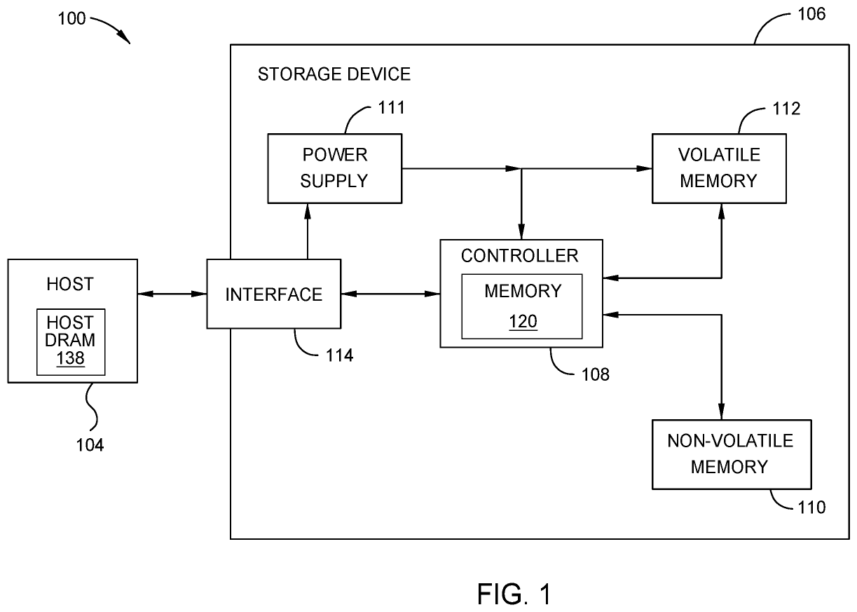

FIG. 1 is a schematic block diagram illustrating a storage system 100 in which storage device 106 may function as a storage device for a host device 104, in accordance with one or more techniques of this disclosure. For instance, the host device 104 may utilize non-volatile media units 110 included in storage device 106 to store and retrieve data. The host device 104 comprises a host DRAM 138. In some examples, the storage system 100 may include a plurality of storage devices, such as the storage device 106, which may operate as a storage array. For instance, the storage system 100 may include a plurality of storages devices 106 configured as a redundant array of inexpensive/independent disks (RAID) that collectively function as a mass storage device for the host device 104.

The storage system 100 includes a host device 104 which may store and/or retrieve data to and/or from one or more storage devices, such as the storage device 106. As illustrated in FIG. 1, the host device 104 may communicate with the storage device 106 via an interface 114. The host device 104 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

The storage device 106 includes a controller 108, non-volatile memory 110 (NVM 110), a power supply 111, volatile memory 112, and an interface 114. The controller 108 comprises an internal memory 120 or buffer. In some examples, the storage device 106 may include additional components not shown in FIG. 1 for sake of clarity. For example, the storage device 106 may include a printed board (PB) to which components of the storage device 106 are mechanically attached and which includes electrically conductive traces that electrically interconnect components of the storage device 106, or the like. In some examples, the physical dimensions and connector configurations of the storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the storage device 106 may be directly coupled (e.g., directly soldered) to a motherboard of the host device 104.

The interface 114 of the storage device 106 may include one or both of a data bus for exchanging data with the host device 104 and a control bus for exchanging commands with the host device 104. The interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. The electrical connection of the interface 114 (e.g., the data bus, the control bus, or both) is electrically connected to the controller 108, providing electrical connection between the host device 104 and the controller 108, allowing data to be exchanged between the host device 104 and the controller 108. In some examples, the electrical connection of the interface 114 may also permit the storage device 106 to receive power from the host device 104. For example, as illustrated in FIG. 1, the power supply 111 may receive power from the host device 104 via the interface 114.

The storage device 106 includes NVM 110, which may include a plurality of media units or memory devices. NVM 110 may be configured to store and/or retrieve data. For instance, a media unit of NVM 110 may receive data and a message from the controller 108 that instructs the memory device to store the data. Similarly, the media unit of NVM 110 may receive a message from the controller 108 that instructs the memory device to retrieve data. In some examples, each of the media units may be referred to as a die. In some examples, a single physical chip may include a plurality of dies (i.e., a plurality of memory devices). In some examples, each memory devices may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each media unit of NVM 110 may include any type of non-volatile memory devices, such as flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

The NVM 110 may comprise a plurality of flash memory devices. Flash memory devices may include NAND or NOR based flash memory devices, and may store data based on a charge contained in a floating gate of a transistor for each flash memory cell. In NAND flash memory devices, the flash memory device may be divided into a plurality of blocks which may divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines. Furthermore, NAND flash memory devices may be 2D or 3D devices, and may be single level cell (SLC), multi-level cell (MLC), triple level cell (TLC), or quad level cell (QLC). The controller 108 may write data to and read data from NAND flash memory devices at the page level and erase data from NAND flash memory devices at the block level.

The storage device 106 includes a power supply 111, which may provide power to one or more components of the storage device 106. When operating in a standard mode, the power supply 111 may provide power to the one or more components using power provided by an external device, such as the host device 104. For instance, the power supply 111 may provide power to the one or more components using power received from the host device 104 via the interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The storage device 106 also includes volatile memory 112, which may be used by controller 108 to store information. Volatile memory 112 may be comprised of one or more volatile memory devices. In some examples, the controller 108 may use volatile memory 112 as a cache. For instance, the controller 108 may store cached information in volatile memory 112 until cached information is written to non-volatile memory 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)).

The storage device 106 includes a controller 108, which may manage one or more operations of the storage device 106. For instance, the controller 108 may manage the reading of data from and/or the writing of data to the NVM 110. In some embodiments, when the storage device 106 receives a write command from the host device 104, the controller 108 may initiate a data storage command to store data to the NVM 110 and monitor the progress of the data storage command. The controller 108 may determine at least one operational characteristic of the storage system 100 and store the at least one operational characteristic to the NVM 110. In some embodiments, when the storage device 106 receives a write command from the host device 104, the controller 108 temporarily stores the data associated with the write command in the internal memory 120 before sending the data to the NVM 110.

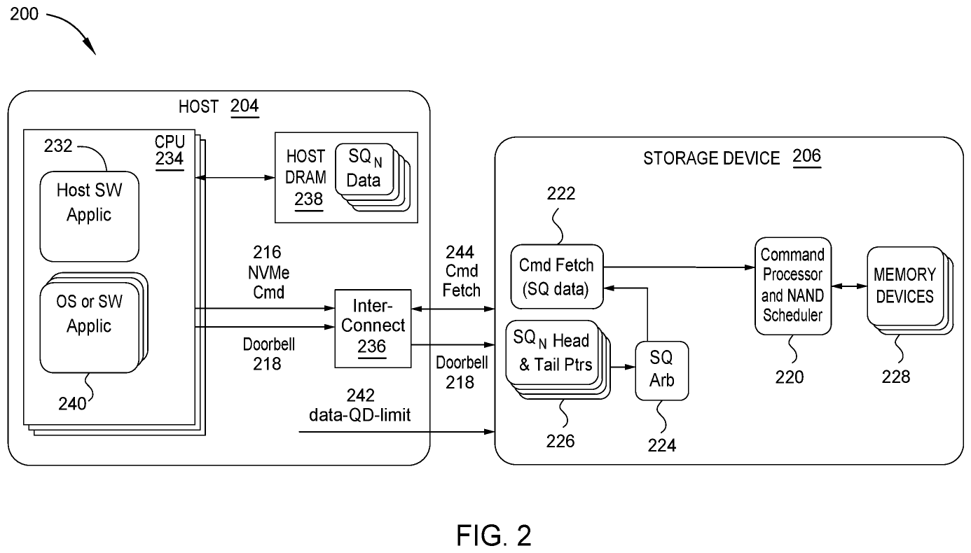

FIG. 2 illustrates a storage system 200 comprising a storage device 206 coupled to a host device 204, according to another embodiment. Storage system 200 may be the storage system 100, the host device 104, and the storage device 106 of FIG. 1.

The storage device 206 may send and receive commands and data from the host device 204, and comprises a command processor 220. The command processor 220 may be the controller 108 of FIG. 1. The command processor 220 may schedule memory device access, such as NAND access, and may perform a read to a memory device or media unit prior to a previously received command requiring a write to the same memory device. The command processor 220 is coupled to one or more memory devices 228 and a command fetch 222. The one or more memory devices 228 may be NAND non-volatile memory devices. The command fetch 222 is coupled to a submission queue arbitration 224. The submission queue arbitration 224 is coupled to one or more submission queue head and tail pointers 226.

The host device 204 is comprised of one or more host software applications 232 coupled to one or more processing units or CPU applications 234. In one embodiment, the software application 232 has limited solid-state drive queue depth in order to derive a latency QoS for each user of the system 200. The host device 204 further comprises an operating system (OS) or software application 240 without an associated QoS. The CPU 234 is coupled to an interconnect 236 and to a host DRAM 238. The host DRAM 238 may store submission queue data. The interconnect 236 is coupled to the storage device 206. The interconnect 236 may be in communication with both the submission queue head and tail pointers 226 and the command fetch 222.

The CPU 234 generates one or more commands 216 to send to the storage device 206, and may send and receive commands from the storage device 206 via the command fetch signal 244. The CPU 234 may further send an interrupt or doorbell 218 to the storage device 206 to notify the storage device 206 of the one or more commands 216. The CPU 234 may limit data-queue depth submitted to the storage device 206. Queue depth (QD) is the maximum number of commands queued to the storage device 206, and data-QD is the amount of data associated with the commands queued with a QD. In one embodiment, the data-QD 242 of the storage device 206 is equal to the bandwidth of the storage device 206. Data-QD 242 is limited to the highest level under which the storage device 206 can still maintain a desired latency QoS. The command processor 220 then processes the commands received from the host device 204.

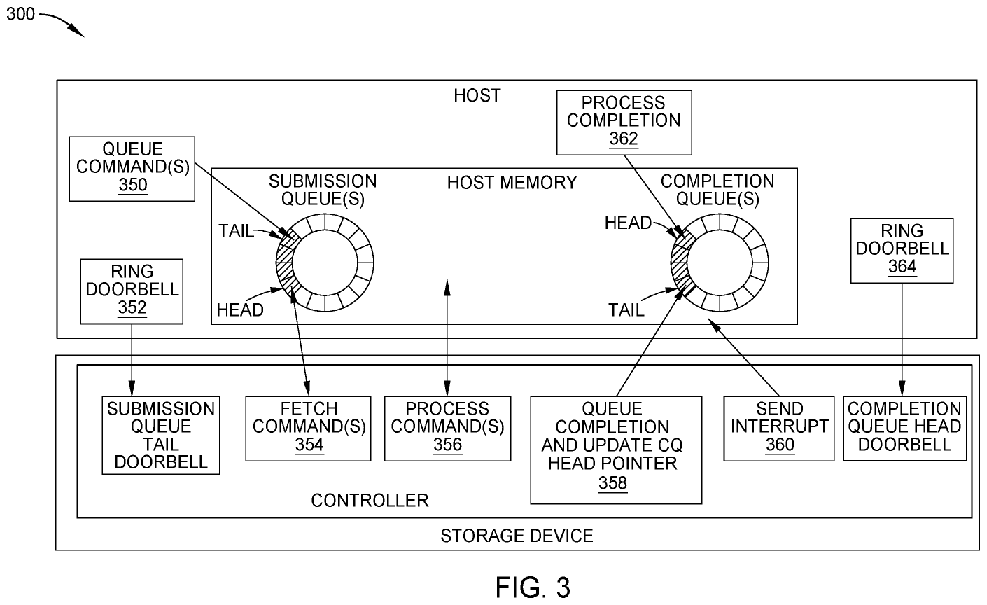

FIG. 3 is a block diagram illustrating a method 300 of operating a storage device to execute a read or write command, according to one embodiment. Method 300 may be used with the storage system 100 having a host device 104 and a storage device 106 comprising a controller 108. Method 300 may further be used with the storage system 200 having a host device 204 and a storage device 206 comprising a command processor 220.

Method 300 begins at operation 350, where the host device writes a command into a submission queue as an entry. The host device may write one or more commands into the submission queue at operation 350. The commands may be read commands or write commands. The host device may comprise one or more submission queues.

In operation 352, the host device writes one or more updated submission queue tail pointers and rings a doorbell or sends an interrupt signal to notify or signal the storage device of the new command that is ready to be executed. The doorbell signal may be the doorbell 218 of FIG. 2. The host may write an updated submission queue tail pointer and send a doorbell or interrupt signal for each of the submission queues if there are more than one submission queues. In operation 354, in response to receiving the doorbell or interrupt signal, a controller of the storage device fetches the command from the one or more submission queue, and the controller receives the command.

In operation 356, the controller processes the command and writes or transfers data associated with the command to the host device memory. The controller may process more than one command at a time. For example, processing a first command received may comprise partially writing data associated with the first command to a memory device, such as a NAND memory device. The partial write may be a first pass program of the data. Upon receiving a second command, the controller may partially write the second command, and complete the write of the first command (i.e., a second pass program).

In operation 358, once the command has been fully processed, the controller writes a completion entry corresponding to the executed command to a completion queue of the host device and moves or updates the CQ head pointer to point to the newly written completion entry.

In operation 360, the controller generates and sends an interrupt signal or doorbell to the host device. The interrupt signal indicates that the command has been executed and data associated with the command is available in the memory device. The interrupt signal further notifies the host device that the completion queue is ready to be read or processed.

In operation 362, the host device processes the completion entry. In operation 364, the host device writes an updated CQ head pointer to the storage device and rings the doorbell or sends an interrupt signal to the storage device to release the completion entry.

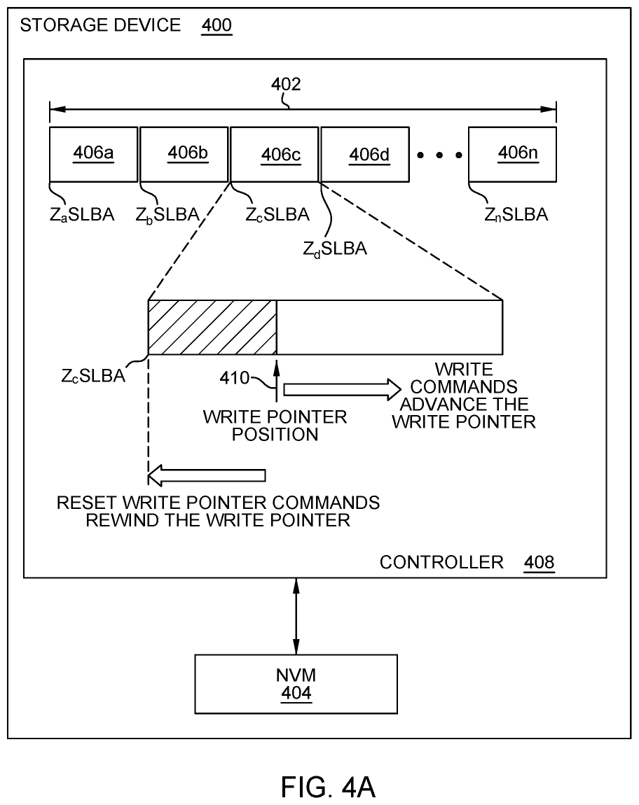

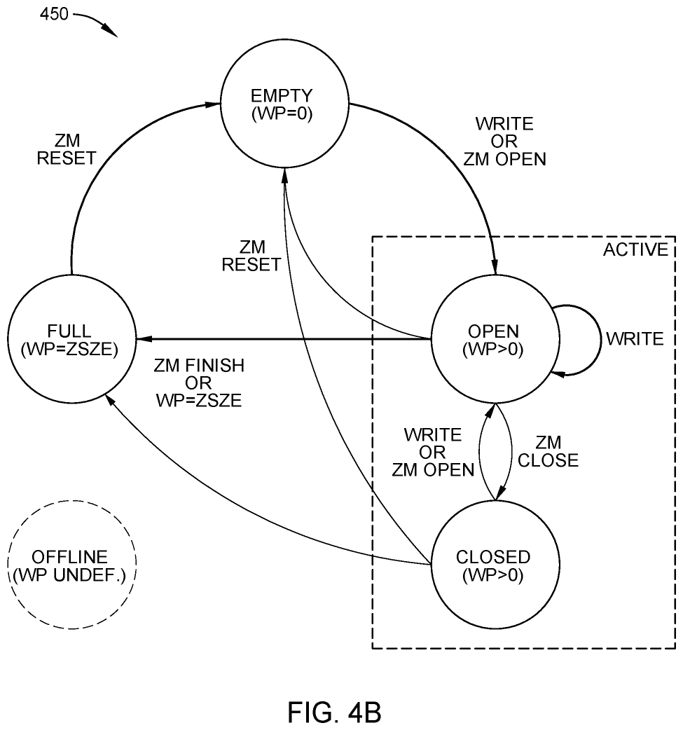

FIG. 4A illustrates a Zoned Namespaces (ZNS) 402 view utilized in a storage device 400, according to one embodiment. The storage device 400 may present the ZNS 402 view to a host device. FIG. 4B illustrates a state diagram 450 for the ZNS 402 of the storage device 400, according to one embodiment. The storage device 400 may be the storage device 106 of the storage system 100 of FIG. 1 or the storage device 206 of the storage system 200 of FIG. 2. The storage device 400 may have one or more ZNS 402, and each ZNS 402 may be different sizes. The storage device 400 may further comprise one or more conventional namespaces in addition to the one or more Zoned Namespaces 402. Moreover, the ZNS 402 may be a zoned block command (ZBC) for SAS and/or a zoned-device ATA command set (ZAC) for SATA.

In the storage device 400, the ZNS 402 is the quantity of NVM that can be formatted into logical blocks such that the capacity is divided into a plurality of zones 406a-406n (collectively referred to as zones 406). Each of the zones 406 comprise a plurality of physical or erase blocks (now shown) of a media unit or NVM 404, and each of the erase blocks are associated a plurality of logical blocks (not shown). When the controller 408 receives a command, such as from a host device (not shown) or the submission queue of a host device, the controller 408 can read data from and write data to the plurality of logical blocks associated with the plurality of erase blocks of the ZNS 402. Each of the logical blocks is associated with a unique LBA or sector.

In one embodiment, the NVM 404 is a NAND device. The NAND device comprises one or more dies. Each of the one or more dies comprises one or more planes. Each of the one or more planes comprises one or more erase blocks. Each of the one or more erase blocks comprises one or more wordlines (e.g., 256 wordlines). Each of the one or more wordlines may be addressed in one or more pages. For example, an MLC NAND die may use upper page and lower page to reach the two bits in each cell of the full wordline (e.g., 16 kB per page). Furthermore, each page can be accessed at a granularity equal to or smaller than the full page. A controller can frequently access NAND in user data granularity LBA sizes of 512 bytes. Thus, as referred to in the below description, NAND locations are equal to a granularity of 512 bytes. As such, an LBA size of 512 bytes and a page size of 16 kB for two pages of an MCL NAND results in about 16 NAND locations per wordline. However, the NAND location size is not intended to be limiting, and is merely used as an example.

When data is written to an erase block, one or more logical blocks are correspondingly updated within a zone 406 to track where the data is located within the NVM 404. Data may be written to one zone 406 at a time until a zone 406 is full, or to multiple zones 406 such that multiple zones 406 may be partially full. Similarly, when writing data to a particular zone 406, data may be written to the plurality of erase blocks one block at a time, in sequential order of NAND locations, page-by-page, or wordline-by-wordline, until moving to an adjacent block (i.e., write to a first erase block until the first erase block is full before moving to the second erase block), or to multiple blocks at once, in sequential order of NAND locations, page-by-page, or wordline-by-wordline, to partially fill each block in a more parallel fashion (i.e., writing the first NAND location or page of each erase block before writing to the second NAND location or page of each erase block).

Each of the zones 406 is associated with a zone starting logical block address (ZSLBA). The ZSLBA is the first available LBA in the zone 406. For example, the first zone 406a is associated with ZₐSLBA, the second zone 406b is associated with Z_{b}SLBA, the third zone 406c is associated with Z_{c}SLBA, the fourth zone 406d is associated with Z_{d}SLBA, and the n^{th} zone 406n (i.e., the last zone) is associated with ZₙSLBA. Each zone 406 is identified by its ZSLBA, and is configured to receive sequential writes (i.e., writing data to the NVM 110 in the order the write commands are received).

As data is written to a zone 406, a write pointer 410 is advanced or updated to point to or to indicate the next available block in the zone 406 to write data to in order to track the next write starting point (i.e., the completion point of the prior write equals the starting point of a subsequent write). Thus, the write pointer 410 indicates where the subsequent write to the zone 406 will begin. Subsequent write commands are ‘zone append’ commands, where the data associated with the subsequent write command appends to the zone 406 at the location the write pointer 410 is indicating as the next starting point. An ordered list of LBAs within the zone 406 may be stored for write ordering. Each zone 406 may have its own write pointer 410. Thus, when a write command is received, a zone is identified by its ZSLBA, and the write pointer 410 determines where the write of the data begins within the identified zone.

FIG. 4B illustrates a state diagram 450 for the ZNS 402 of FIG. 4A. In the state diagram 450, each zone may be in a different state, such as empty, active, full, or offline. When a zone is empty, the zone is free of data (i.e., none of the erase blocks in the zone are currently storing data) and the write pointer is at the ZSLBA (i.e., WP=0). An empty zone switches to an open and active zone once a write is scheduled to the zone or if a zone open command is issued by the host. Zone management (ZM) commands can be used to move a zone between zone open and zone closed states, which are both active states. If a zone is active, the zone comprises open blocks that may be written to, and the host may be provided a description of recommended time in the active state. The controller may comprise the ZM.

The term “written to” includes programming user data on 0 or more word lines in an erase block, erasure, and/or partially filled word lines in an erase block when user data has not filled all of the available word lines. The term “written to” may further include closing a zone due to internal drive handling needs (open block data retention concerns because the bits in error accumulate more quickly on open erase blocks), the storage device 400 closing a zone due to resource constraints, like too many open zones to track or discovered defect state, among others, or a host device closing the zone for concerns such as there being no more data to send the drive, computer shutdown, error handling on the host, limited host resources for tracking, among others.

The active zones may be either open or closed. An open zone is an empty or partially full zone that is ready to be written to and has resources currently allocated. The data received from the host device with a write command or zone append command may be programmed to an open erase block that is not currently filled with prior data. New data pulled-in from the host device or valid data being relocated may be written to an open zone. Valid data may be moved from one zone (e.g. the first zone 402a) to another zone (e.g. the third zone 402c) for garbage collection purposes. A closed zone is an empty or partially full zone that is not currently receiving writes from the host in an ongoing basis. The movement of a zone from an open state to a closed state allows the controller 408 to reallocate resources to other tasks. These tasks may include, but are not limited to, other zones that are open, other conventional non-zone regions, or other controller needs.

In both the open and closed zones, the write pointer is pointing to a place in the zone somewhere between the ZSLBA and the end of the last LBA of the zone (i.e., WP>0). Active zones may switch between the open and closed states per designation by the ZM, or if a write is scheduled to the zone. Additionally, the ZM may reset an active zone to clear or erase the data stored in the zone such that the zone switches back to an empty zone. Once an active zone is full, the zone switches to the full state. A full zone is one that is completely filled with data, and has no more available blocks to write data to (i.e., WP=zone capacity (ZCAP)). Read commands of data stored in full zones may still be executed.

The ZM may reset a full zone, scheduling an erasure of the data stored in the zone such that the zone switches back to an empty zone. When a full zone is reset, the zone may not be immediately cleared of data, though the zone may be marked as an empty zone ready to be written to. However, the reset zone must be erased prior to switching to an active zone. A zone may be erased any time between a ZM reset and a ZM open. An offline zone is a zone that is unavailable to write data to. An offline zone may be in the full state, the empty state, or in a partially full state without being active.

Since resetting a zone clears or schedules an erasure of the data stored in the zone, the need for garbage collection of individual erase blocks is eliminated, improving the overall garbage collection process of the storage device 400. The storage device 400 may mark one or more erase blocks for erasure. When a new zone is going to be formed and the storage device 400 anticipates a ZM open, the one or more erase blocks marked for erasure may then be erased. The storage device 400 may further decide and create the physical backing of the zone upon erase of the erase blocks. Thus, once the new zone is opened and erase blocks are being selected to form the zone, the erase blocks will have been erased. Moreover, each time a zone is reset, a new order for the LBAs and the write pointer 410 for the zone 406 may be selected, enabling the zone 406 to be tolerant to receive commands out of sequential order. The write pointer 410 may optionally be turned off such that a command may be written to whatever starting LBA is indicated for the command.

Referring back to FIG. 4A, when the controller 408 initiates or pulls-in a write command, the controller 408 may select an empty zone 406 to write the data associated with the command to, and the empty zone 406 switches to an active zone 406. As used herein, the controller 408 initiating or pulling-in a write command comprises receiving a write command or direct memory access (DMA) reading the write command. The write command may be a command to write new data, or a command to move valid data to another zone for garbage collection purposes. The controller 408 is configured to DMA read or pull-in new commands from a submission queue populated by a host device.

In an empty zone 406 just switched to an active zone 406, the data is written to the zone 406 starting at the ZSLBA, as the write pointer 410 is indicating the logical block associated with the ZSLBA as the first available logical block. The data may be written to one or more erase blocks or NAND locations that have been allocated for the physical location of the zone 406. After the data associated with the write command has been written to the zone 406, the write pointer 410 is updated to point to the next available block in the zone 406 to track the next write starting point (i.e., the completion point of the first write). Alternatively, the controller 408 may select an active zone to write the data to. In an active zone, the data is written to the logical block indicated by the write pointer 410 as the next available block.

In some embodiments, a NAND location may be equal to a wordline. In such an embodiment, if the write command is smaller than a wordline, the controller may optionally aggregate several write commands in another memory location such as DRAM or SRAM prior to programming a full wordline composed of multiple write commands. Write commands that are longer than a wordline will be able to program and fill a complete wordline with some of the data, and the excess data beyond a wordline will be used to fill the next wordline. However, a NAND location is not limited to being equal to a wordline, and may have a larger or smaller size than a wordline. For example, in some embodiments, a NAND location may be equal to the size of a page.

For example, the controller 408 may receive, pull-in, or DMA read a first write command to a third zone 406c, or a first zone append command. The host identifies sequentially which logical block of the zone 406 to write the data associated with the first command to. The data associated with the first command is then written to the first or next available LBA(s) in the third zone 406c as indicated by the write pointer 410, and the write pointer 410 is advanced or updated to point to the next available LBA available for a host write (i.e., WP>0). If the controller 408 receives or pulls-in a second write command to the third zone 406c, the data associated with the second write command is written to the next available LBA(s) in the third zone 406c identified by the write pointer 410. Once the data associated with the second command is written to the third zone 406c, the write pointer 410 once again advances or updates to point to the next available LBA available for a host write. Resetting the third zone 406c moves the write pointer 410 back to the Z_{c}SLBA (i.e., WP=0), and the third zone 406c switches to an empty zone.

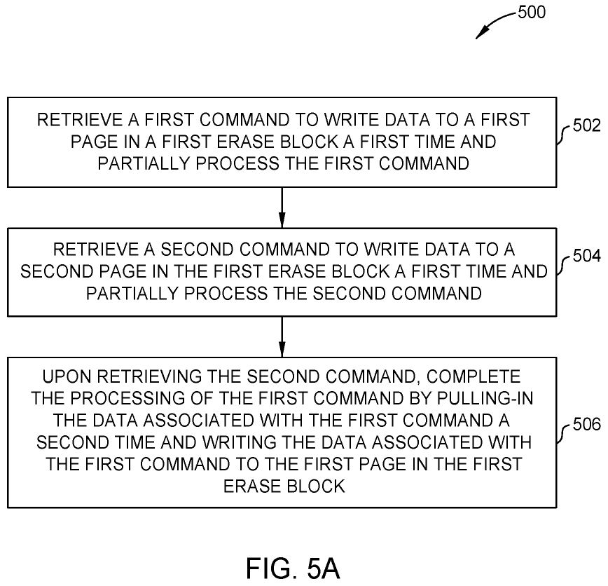

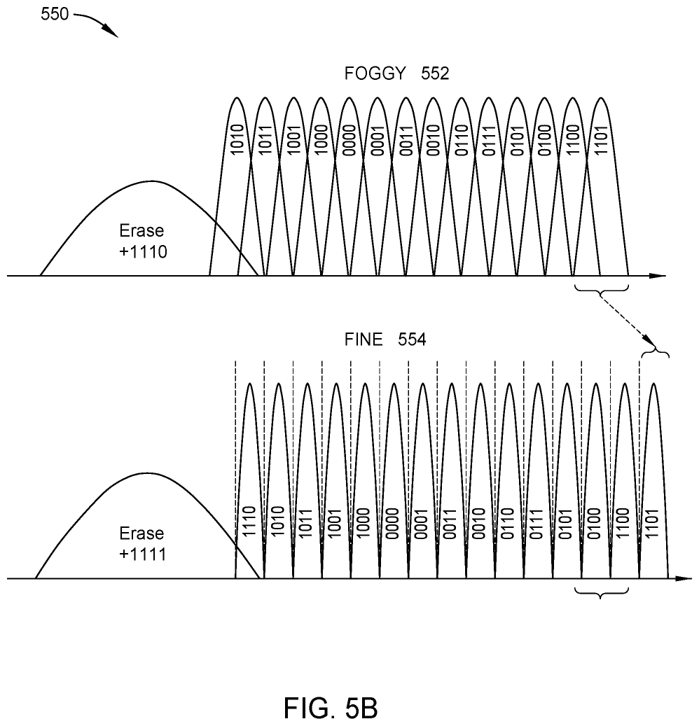

FIG. 5A illustrates a method 500 for operating a storage device, according to one embodiment. FIG. 5B illustrates an exemplary diagram 550 demonstrating the expected voltage distribution for the first pass programming (i.e., the “foggy” programming) and the second pass programming (i.e., the “fine” programming) as referred to in the method 500. Method 500 may be utilized with the storage system 100 of FIG. 1 comprising the controller 108 or the storage system 200 of FIG. 2 comprising the command processor 220. Method 500 may be implemented with a storage device utilizing ZNS, such as the ZNS 402 of FIG. 4.

In operation 502, a first command to write data to a first page or a first NAND location in a first erase block is retrieved, the data associated with the first command is pulled-in, DMA read, or transferred to the storage device a first time from a host device, and the first command is partially processed. The first erase block may be in a first zone. The first erase block is disposed within a media unit, such as a NAND memory device. In one embodiment, the media unit is a QLC NAND media unit. Partially processing the first command may comprise reading the data associated with the first command, and partially writing or performing a first pass programming of the data associated with the first command to the first page or first NAND location in the first erase block (i.e., a ‘foggy’ programming of the data). The partial writing of the data is performed at a first voltage target that is applied to each cell of the first page or first NAND location for a first amount of time. The controller may optionally discard the data associated with the first command.

In one embodiment, the reason for the foggy-fine programming and the interlaced programming of the NAND page orders is due to the high voltages applied during the foggy state, which cause high disturbances on the neighboring pages. Keeping the foggy programming voltages two NAND pages in the future means that the fine programming steps of lower voltages do not disturb the neighboring pages and the data of the neighboring pages. Thus, the most recently completed fine programmed page is only slightly affected by the fine programming of the ongoing fine programming step. Similarly, the same NAND page is two pages away from the page that experienced the foggy program voltages.

Since the data associated with the first command is only partially written to the first page (or first NAND location) or discarded completely, the data may be unreadable in some implementations. Additionally, though the data may be partially written, the first command is incomplete and the data is stored in the host device, rather than in the controller. While the data may pass through an internal memory of the controller between retrieving the first command and partially writing the data associated with the first command to the first erase block, the data is not stored in the controller memory for the duration of the processing of the first command.

In operation 504, a second command to write data to a second page or a second NAND location in the first erase block is retrieved, the data associated with the second command is pulled-in, DMA read, or transferred to the storage device a first time from the host device, and the second command is partially processed. Partially processing the second command may comprise reading the data associated with the second command, and partially writing or performing a first pass programming of the data associated with the second command to the second page or second NAND location in the first erase block (i.e., a ‘foggy’ programming of the data). The partial writing of the data is performed at the first voltage target. In one embodiment, the second command may be written to a second erase block of the media unit. The controller may optionally discard the data associated with the second command.

In operation 506, upon retrieving the second command, the processing of the first command is completed by pulling-in, DMA reading, or transferring the data associated with the first command a second time and writing the data associated with the first command to the first page or first NAND location in the first erase block. Writing the data associated with the first command upon retrieving the second command is performed at a second voltage target greater than the first voltage target and is a second pass programming of the data (i.e., a ‘fine’ programming of the data). The second voltage target is applied to each cell of the first page or first NAND location for a second amount of time greater than the first amount of time. Retrieving the second command triggers the full write of the data associated with the first command (i.e., the write of the data associated with the first command is not completed until the storage device receives the second command). Thus, the first command is being held ‘hostage’ (i.e., uncompleted, only partially completed, and/or paused) until the second command is retrieved. Holding the first command ‘hostage’ may further comprise withholding or delaying a write completion entry or notification from a host device. Once the processing of the first command is complete, the data is readable from the media unit.

Following the write of the data associated with the first command to the first page or first NAND location in the first erase block, the controller signals the completion of the first command. The controller may signal the completion of the first command by writing a first completion entry corresponding to the first command to the completion queue, updating the completion queue tail to point to the first completion entry, and ringing the doorbell to the host device. Method 500 may then repeat one or more times as subsequent commands are received from the host device.

FIG. 5B illustrates an exemplary diagram 550 demonstrating the expected voltage distribution for the first pass programming (i.e., the “foggy” programming) and the second pass programming (i.e., the “fine” programming). As shown, the foggy state 552 of programming applies large pulses of voltage to program the cells of the page or NAND location while the fine state 554 applies smaller, more precise pulses of voltage to program the cells of the page or NAND location. The voltage of the foggy state 552 may not be well controlled for a final distribution of voltage states. Such a lack of precision is due to the foggy programming state moving the voltage distribution through a large change for speed. The voltage of the fine state 554 is more precisely applied such that the voltage state is finalized in a precisely controlled state. To reach the precisely controlled state, slower programming steps with smaller voltage increments are applied, and the media circuitry may apply extra sensing of the intermediate and/or final status during these fine voltage programming steps.

The above method describes an embodiment where the data associated with a host write command is large enough to fill a page or a NAND location (i.e., the data associated with the host command equals one page size or one NAND location size). However, in embodiments where the host write command is too small to fill a page or a NAND location (i.e., the data associated with the host command is less than one page size or one NAND location size) or too big for one page or one NAND location (i.e., the data associated with the host command is greater than one page size or one NAND location size), the above method is still applicable.

In embodiments where the data associated with a host write command is too large to fill a page or a NAND location, the data associated with the host write command is first broken down into page sizes or NAND location sizes. In embodiments where the data associated with a host write command is too small to fill a page or a NAND location, more than one host command may be needed to fill a page or a NAND location, and multiple host write commands may be aggregated to fill a page or a NAND location. Moreover, host write commands that are too small to fill a page or a NAND location may optionally be coalesced. Coalescing write commands is an independent decision by the storage device that may be utilized, and the storage device may take into consideration queue depth when choosing whether to coalesce write commands.

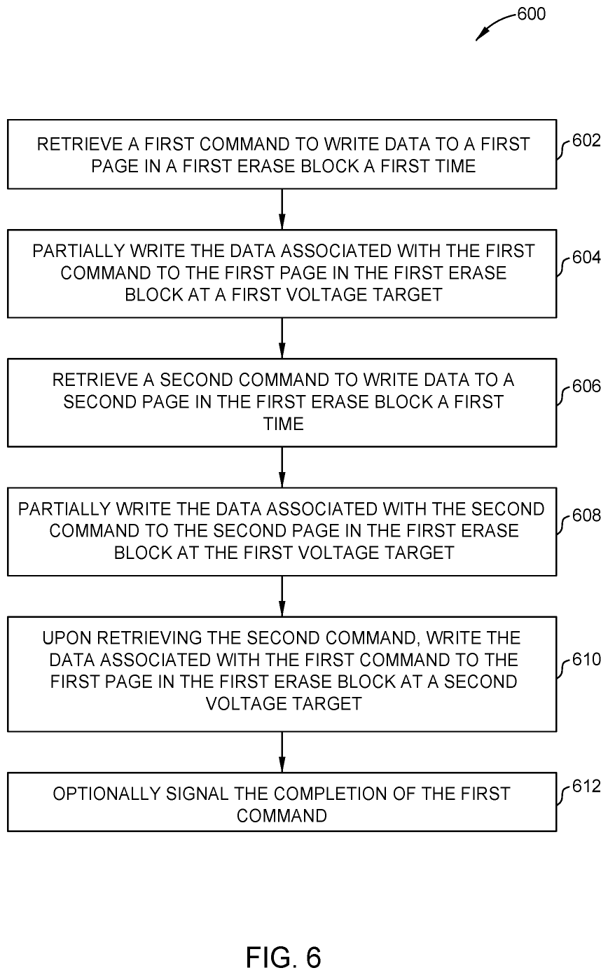

FIG. 6 illustrates a method 600 for operating a storage device, according to another embodiment. Method 600 may be utilized with the storage device 106 of FIG. 1 or the storage device 206 of FIG. 2. Method 600 may be implemented with a storage device utilizing ZNS, such as the ZNS 402 of FIG. 4.

In operation 602, a first command to write data to a first page or a first NAND location in a first erase block is retrieved by a controller of the storage device and the data associated with the first command is pulled-in, DMA read, or transferred a first time. The first erase block may be in a first zone. In one embodiment, the first command is retrieved from a host device, such as the host device 104 of FIG. 1 or the host device 204 of FIG. 2. In another embodiment, the data associated with the first command is retrieved from another erase block for garbage collection purposes. The first erase block is disposed within a media unit or media, such as a NAND media unit. In one embodiment, the media unit is a QLC NAND media unit. Retrieving the first command comprises performing a first read of the data associated with the first command from the host device.

In operation 604, the data associated with the first command is partially written to the first page or first NAND location in the first erase block at a first voltage target. The first voltage level is applied to each cell of the first page or first NAND location for a first amount of time. The partial writing of the data may be a ‘foggy’ write or programming, as described in FIG. 5B. The partial writing may be a first pass program of the data. The controller may optionally discard the data associated with the first command.

Since the data associated with the first command is only partially written to the first erase block or discarded, the data is unreadable. Additionally, though the data is partially written, the first command is incomplete and the data is still stored in the host device, rather than in the controller. While the data may pass through an internal memory of the controller between retrieving the first command and partially writing the data associated with the first command to the first erase block, the data is not stored in the controller memory for the duration of the processing of the first command.

In operation 606, a second command to write data to a second page or a second NAND location in the first erase block is retrieved by the controller and the data associated with the second command to write data is pulled-in, DMA read, or transferred a first time, similar to operation 602. Retrieving the second command comprises performing a first read of the data associated with the second command from the host device. In one embodiment, the second command is retrieved from a host device, such as the host device 104 of FIG. 1 or the host device 204 of FIG. 2. In another embodiment, the data associated with the second command is retrieved from another erase block for garbage collection purposes.

In operation 608, the data associated with the second command is partially written to the second page or second NAND location in the first erase block at the first voltage target, similar to operation 604. In one embodiment, the second command may be written to a second erase block of the media unit. The controller may optionally discard the data associated with the second command.

In operation 610, upon retrieving the second command in operation 606, the data associated with the first command is pulled-in, DMA read, or transferred a second time and written to the first page or first NAND location in the first erase block at a second voltage target. The second voltage target is applied to each cell of the first page or first NAND location for a second amount of time greater than the first amount of time. The writing of the data at the second voltage target may be a ‘fine’ write, as described in FIG. 5B. The writing of the data at the second voltage target may be a second pass program of the data. Writing the data associated with the first command at the second voltage target comprises performing a second read of the data associated with the first command from the host device.

After the writing of the data at the second voltage target, the data is readable from the storage device. Retrieving the second command triggers the full write of the data associated with the first command (i.e., the write of the data associated with the first command is not completed until the storage device receives the second command). Thus, the first command is being held ‘hostage’ (i.e., uncompleted, only partially completed, and/or paused) until the second command is received.

In operation 612, the controller optionally signals the completion of the first command. The controller signals the completion of the first command for commands received from a host device. The controller may signal the completion of the first command by writing a first completion entry corresponding to the first command to the completion queue, updating the completion queue tail to point to the first completion entry, and ringing the doorbell to the host device. Unlike conventional methods, the first completion entry is written to the completion queue after the write of the data associated with the first command has been fully processed (i.e., the processing of the command is not occurring in the background).

If the data associated with the first command was retrieved for garbage collection purposes, the controller does not signal the completion of the first command. As such, when the data associated with the first command is retrieved for garbage collection purposes, the first command is not paused or held ‘hostage’ from the perspective of the host device.

Method 600 continues on in the same manner as more commands are received. For example, a third command to write data to a third page or a third NAND location in the first erase block (or to a different erase block) may be retrieving and data associated with a third command is pulled-in, DMA read, or transferred a first time after writing the first completion entry corresponding to the first write command. The data associated with the third command is then partially written to the third page or third NAND location in the first erase block or discarded. Upon retrieving the third command, the data associated with the second command is pulled-in, DMA read, or transferred a second time and written to the second page or second NAND location in the first erase block at the second voltage target. The controller may signal the completion of the second command by writing a second completion entry corresponding to the second command to the completion queue, updating the completion queue tail to point to the second completion entry, and ringing the doorbell to the host device.

Thus, once new commands are retrieved, the new commands are partially written to a new page or a new NAND location at the first voltage target, and the previously retrieved command is written to a different page or a different NAND location at the second voltage target. In other words, a first pass programming of the new command is performed, and a second pass programming of the previously received command is performed.

The above method describes an embodiment where the data associated with a host write command is large enough to fill a page or a NAND location (i.e., the data associated with the host command equals one page size or one NAND location size). However, in embodiments where the host write command is too small to fill a page or a NAND location (i.e., the data associated with the host command is less than one page size or one NAND location size) or too big for one page or one NAND location (i.e., the data associated with the host command is greater than one page size or one NAND location size), the above method is still applicable.

In embodiments where the data associated with a host write command is too large to fill a page or a NAND location, the data associated with the host write command is first broken down into page sizes or NAND location sizes. In embodiments where the data associated with a host write command is too small to fill a page or a NAND location, more than one host command may be needed to fill a page or a NAND location, and multiple host write commands may be aggregated to fill a page or a NAND location. Moreover, host write commands that are too small to fill a page or a NAND location may optionally be coalesced. Coalescing write commands is an independent decision by the storage device that may be utilized, and the storage device may take into consideration queue depth when choosing whether to coalesce write commands.

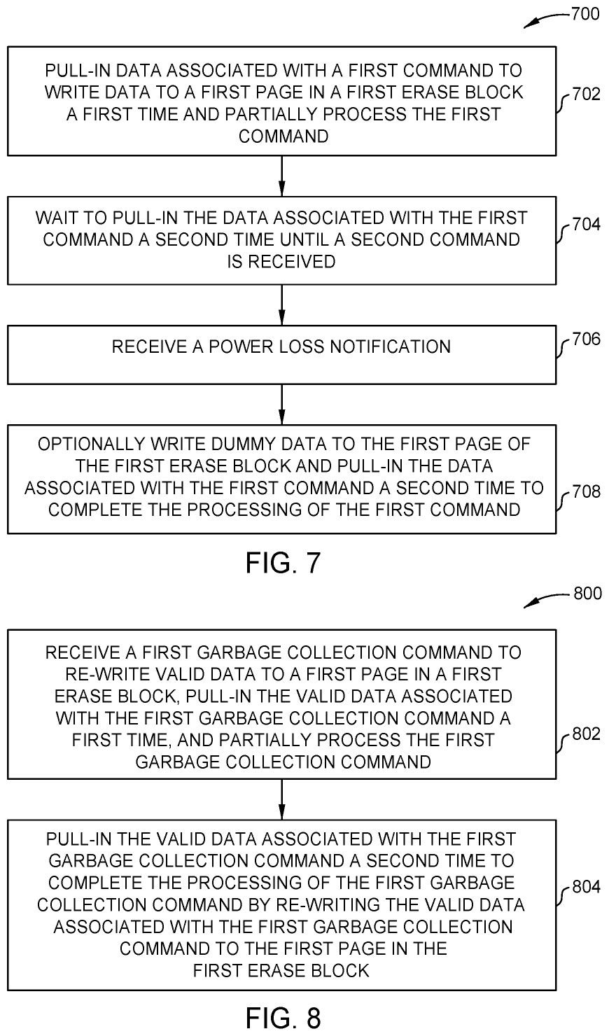

FIG. 7 illustrates a method 700 of operating a storage device during a power fail, according to one embodiment. Method 700 may be utilized with the storage system 100 of FIG. 1 comprising the controller 108 or the storage system 200 of FIG. 2 comprising the command processor 220. Method 700 may be implemented with a storage device utilizing ZNS, such as the ZNS 402 of FIG. 4. Additionally, method 700 may be implemented with a storage device not utilizing ZNS.

In operation 702, a first command to write data to a first page or a first NAND location in a first erase block is retrieved, the data associated with the first command is pulled-in or DMA read a first time, and the first command is partially processed. The first erase block may be in a first zone. The first erase block is disposed within a media unit or media, such as a NAND media unit. In one embodiment, the media unit is a QLC NAND media unit. Partially processing the first command may comprise reading the data associated with the first command, and partially writing or performing a first pass programming of the data associated with the first command to the first page in the first erase block (i.e., a ‘foggy’ programming of the data), as described in FIG. 5B. The partial writing of the data is performed at a first voltage target that is applied to each cell of the first page or first NAND location for a first amount of time. The controller may optionally discard the data associated with the first command.

In operation 704, the storage device holds the first command ‘hostage’ (i.e., uncompleted, only partially completed, and/or paused) and waits to pull-in or DMA read the data associated with the first command a second time to complete the processing of the first command until a second command is received. In operation 706, a power loss or power fail notification is received. The power loss notification is received prior to a second command being received, pulled-in, or DMA read.

In operation 708, the storage device may optionally foggy program dummy data to the second page or a second NAND location of the first erase block and pull-in or DMA read the data associated with the first command a second time to complete the processing of the first command. Pulling-in or DMA reading the data associated with the first command a second time enables the storage device to complete the writing of the data associated with the first command such that the data is readable from the media unit, as described above in methods 500 and 600. Once the processing of the first command is complete, the data is readable from the media unit. A write completion may then be returned to the host, which signals that the data will be readable to the storage device on the next power up.

Alternatively, upon receiving the power loss notification, the storage device may not complete the first command. In such an embodiment, the pulling-in or DMA reading of the data associated with the first command is not completed a second time, and the program of the data is in an incomplete status. If the storage device fails to complete the first command, the data associated with the first command may not be readable or valid on the next boot. The incomplete write would be handled as the interface specification applies for each SSD. In the case of NVMe, the write would not be complete and the data does not need to be readable.

Methods 500, 600, and 700 may each individually be implemented with a storage device not utilizing ZNS. However, storage devices not utilizing ZNS may move valid data from a first erase block to a second erase block for garbage collection purposes. FIG. 8 illustrates a method 900 for operating a storage device not utilizing ZNS during a garbage collection process, according to another embodiment. Method 800 may be utilized with the storage device 106 of FIG. 1 or the storage device 206 of FIG. 2.

In operation 802, a first garbage collection (GC) command to re-write valid data to a first page or a first NAND location in a first erase block is received, the valid data associated with the first GC command is pulled-in or DMA read a first time, and the first GC command is partially processed. The first erase block is disposed within a media unit or media, such as a NAND media unit. In one embodiment, the media unit is a QLC NAND media unit. Partially processing the first GC command may comprise reading the valid data associated with the first GC command, and partially writing or performing a first pass programming of the valid data associated with the first GC command to the first page or first NAND location in the first erase block (i.e., a ‘foggy’ programming of the data), as described in FIG. 5B. The partial writing of the valid data is performed at a first voltage target that is applied to each cell of the first page or first NAND location for a first amount of time. The controller may optionally discard the valid data associated with the first GC command.

In operation 804, the valid data associated with the first GC command is pulled-in or DMA read a second time to complete the processing of the first GC collection command, and the valid data associated with the first GC command is re-written to the first page or first NAND location in the first erase block without waiting to receive a second GC command. Re-writing the valid data associated with the first GC command is performed at a second voltage level greater than the first voltage level and is a second pass programming of the data (i.e., a ‘fine’ programming of the data), as described in FIG. 5B. The second voltage level is a target voltage level for the processing of the command. The second pass programming of the valid data associated with the first GC command may occur in the background as the storage device processes other commands. As such, the storage device does not hold the first GC command ‘hostage’. Once the processing of the first GC command is complete, the valid data is readable from the media unit once more.

The above method describes an embodiment where the data associated with a host write command is large enough to fill a page or a NAND location (i.e., the data associated with the host command equals one page size or one NAND location size). However, in embodiments where the host write command is too small to fill a page or a NAND location (i.e., the data associated with the host command is less than one page size or one NAND location size) or too big for one page or one NAND location (i.e., the data associated with the host command is greater than one page size or one NAND location size), the above method is still applicable.

In embodiments where the data associated with a host write command is too large to fill a page or a NAND location, the data associated with the host write command is first broken down into page sizes or NAND location sizes. In embodiments where the data associated with a host write command is too small to fill a page or a NAND location, more than one host command may be needed to fill a page or a NAND location, and multiple host write commands may be aggregated to fill a page or a NAND location. Moreover, host write commands that are too small to fill a page or a NAND location may optionally be coalesced. Coalescing write commands is an independent decision by the storage device that may be utilized, and the storage device may take into consideration queue depth when choosing whether to coalesce write commands.

By performing a first pass programming of data associated with a first command to partially write the data associated with the first command to an erase block and then performing a second pass programming of the data associated with the first command upon receiving a second command, the data associated with the first command can be stored in the host device until the writing of the data is complete. In doing so, the volatile memory space of the controller, such as the DRAM and/or SRAM, saves space. By storing data in the host device while processing commands, rather than in the internal memory of the controller, the overall SSD performance, throughput, and efficiency is improved. Moreover, the amount of power consumed while processing commands is reduced, which in turn reduces costs associated with the controller.

In one embodiment, a storage device comprises a media unit and a controller coupled to the media unit, wherein a capacity of the media unit is divided into a plurality of zones. The controller configured to retrieve a first command to write data to a first page in a first erase block of the media unit, the first erase block being disposed in a first zone of the plurality of zones, retrieve a second command to write data to a second page in the first erase block, and upon retrieving the second command, write the data associated with the first command to the first page in the first erase block.

The data associated with the first command may be stored in a host device until the data associated with the first command is written to the first page upon receiving the second command. The controller may be further configured to partially write the data associated with the first command to the first page in the first erase block at a first voltage target applied for a first amount of time before retrieving the second command, wherein the data associated with the first command is written to the first page at a second voltage target applied for a second amount of time greater than the first amount of time, and signal a completion of the first command after writing the data associated with the first command to the first page. The controller may be further configured to retrieve a third command to write data to a third page in the first erase block after signaling the completion of the first command, upon retrieving the third command, write the data associated with the second command to the second page in the first erase block, and signal a completion of the second command.

The controller may be further configured to partially write the data associated with the second command to the second page in the first erase block at a first voltage target applied for a first amount of time before retrieving the third command, wherein the data associated with the second command is written to the second page at a second voltage target applied for a second amount of time greater than the first amount of time, and signal a completion of the second command after writing the data associated with the second command to the second page. The controller may be further configured to retrieve a fourth command to write data to a fourth page in the first erase block after signaling the completion of the second command, upon retrieving the fourth command, write the data associated with the third command to the third page in the first erase block, and signal a completion of the third command.

In another embodiment, a storage device comprises a media unit. A capacity of the media unit is divided into a plurality of zones. The storage device further comprises a controller coupled to the media unit. The controller configured to perform a first pass program of data associated with a first command to partially write the data to a first page in a first erase block of a first zone of the plurality of zones, perform the first pass program of data associated with a second command to partially write the data to a second page in the first erase block, upon performing the first pass program of the data associated with the second command, perform a second pass program to write the data associated with the first command to the first page in the first erase block.

The data associated with the first command may be stored in a host device until the data associated with the first command is written to the first page upon performing the second pass program. The first pass program may be performed at a first voltage target applied for a first amount of time and the second pass program may be performed at a second voltage target applied for a second amount of time greater than the first amount of time. The controller may be further configured to signal a completion of the first command after the second pass program of the data associated with the first command is complete.

The controller may be further configured to retrieve a third command to write data to a third page in the first erase block after writing the first completion entry, perform the first pass program of data associated with the third command to partially write the data to the third page in the first erase block, and upon retrieving the third command, perform the second pass program to write the data associated with the second command to the second page in the first erase block. The controller may be further configured to signal a completion of the second command after the data associated with the second command is written to the second page. The data associated with the second command may be stored in a host device until the data associated with the second command is written to the second page upon performing the second pass program.

In yet another embodiment, a storage device comprises a media unit wherein a capacity of the media unit is divided into a plurality of zones, and a controller coupled to the media unit. The controller configured to retrieve a first command to write data to a first page in a first erase block of the storage device, the first erase block being disposed in a first zone of the plurality of zones, partially write the data associated with the first command to the first page in the first erase block at a first voltage target applied for a first amount of time, retrieve a second command to write data to a second page in the first erase block, partially write the data associated with the second command to the second page in the first erase block at the first voltage target, and upon retrieving the second command, write the data associated with the first command to the first page in the first erase block at a second voltage target applied for a second amount of time, the second amount of time being greater than the first amount of time.

The data associated with the first command may be stored in a host device until the data associated with the first command is written at the second voltage target. The controller may be further configured to signal a completion of the first command after writing the data associated with the first command to the first page, retrieve a third command to write data to a third page in the first erase block, partially write the data associated with the third command to the third page in the first erase block at the first voltage target, upon retrieving the third command, write the data associated with the second command to the second page in the first erase block at the second voltage target, and signal a completion of the second command.

The data associated with the second command may be stored in a host device until the data associated with the second command is written at the second voltage target. The controller may be further configured to retrieve a fourth command to write data to a fourth page in the first erase block after writing the second completion entry corresponding to the second write command, partially write the data associated with the fourth command to the fourth page in the first erase block at the first voltage target, upon retrieving the fourth command, write the data associated with the third command to the third page in the first erase block at the second voltage target, and signal a completion of the second command.

While the foregoing is directed to embodiments of the present disclosure, other and further embodiments of the disclosure may be devised without departing from the basic scope thereof, and the scope thereof is determined by the claims that follow.

What is claimed is:

1. A storage device, comprising:
a media unit, wherein a capacity of the media unit is divided into a plurality of zones; and
a controller coupled to the media unit, the controller configured to:
retrieve a first command to write data to a first page in a first erase block of the media unit, the first erase block being disposed in a first zone of the plurality of zones;
retrieve a second command to write data to a second page in the first erase block; and
upon retrieving the second command, write the data associated with the first command to the first page in the first erase block.

2. The storage device of claim 1, wherein the data associated with the first command is stored in a host device until the data associated with the first command is written to the first page upon receiving the second command.

3. The storage device of claim 1, wherein the controller is further configured to:
partially write the data associated with the first command to the first page in the first erase block at a first voltage target applied for a first amount of time before receiving the second command, wherein the data associated with the first command is written to the first page at a second voltage target applied for a second amount of time greater than the first amount of time; and
signal a completion of the first command after writing the data associated with the first command to the first page.

4. The storage device of claim 3, wherein the controller is further configured to:
retrieve a third command to write data to a third page in the first erase block after signaling the completion of the first command;
upon retrieving the third command, write the data associated with the second command to the second page in the first erase block; and
signal a completion of the second command.

5. The storage device of claim 4, wherein the controller is further configured to:
partially write the data associated with the second command to the second page in the first erase block at a first voltage target applied for a first amount of time before retrieving the third command, wherein the data associated with the second command is written to the second page at a second voltage target applied for a second amount of time that is greater than the first amount of time; and
signal a completion of the second command after writing the data associated with the second command to the second page.

6. The storage device of claim 5, wherein the data associated with the second command is stored in a host device until the data associated with the second command is written to the second page at the second voltage target.

7. The storage device of claim 5, wherein the controller is further configured to:
retrieve a fourth command to write data to a fourth page in the first erase block after writing the second completion entry;
upon retrieving the fourth command, write the data associated with the third command to the third page in the first erase block; and
signal a completion of the third command.

8. A storage device, comprising:
a media unit, wherein a capacity of the media unit is divided into a plurality of zones; and
a controller coupled to the media unit, the controller configured to:
perform a first pass program of data associated with a first command to partially write the data to a first page in a first erase block of a first zone of the plurality of zones;
perform the first pass program of data associated with a second command to partially write the data to a second page in the first erase block; and
upon performing the first pass program of the data associated with the second command, perform a second pass program to write the data associated with the first command to the first page in the first erase block.

9. The storage device of claim 8, wherein the data associated with the first command is stored in a host device until the data associated with the first command is written to the first page upon performing the second pass program.

10. The storage device of claim 8, wherein the first pass program is performed at a first voltage target applied for a first amount of time and the second pass program is performed at a second voltage target applied for a second amount of time greater than the first amount of time.

11. The storage device of claim 8, wherein the controller is further configured to:
signal a completion of the first command after the second pass program of the data associated with the first command is complete.

12. The storage device of claim 11, wherein the controller is further configured to:
retrieve a third command to write data to a third page in the first erase block;
perform the first pass program of data associated with the third command to partially write the data to the third page in the first erase block; and
upon retrieving the third command, perform the second pass program to write the data associated with the second command to the second page in the first erase block.

13. The storage device of claim 12, wherein the controller is further configured to:
signal a completion of the second command after the data associated with the second command is written to the second page.

14. The storage device of claim 12, wherein the data associated with the second command is stored in a host device until the data associated with the second command is written to the second page upon performing the second pass program.

15. A storage device, comprising:
a media unit, wherein a capacity of the media unit is divided into a plurality of zones; and
a controller coupled to the media unit, the controller configured to:
retrieve a first command to write data to a first page in a first erase block of the media unit, the first erase block being disposed in a first zone of the plurality of zones;
partially write the data associated with the first command to the first page in the first erase block at a first voltage target applied for a first amount of time;
retrieve a second command to write data to a second page in the first erase block;
partially write the data associated with the second command to the second page in the first erase block at the first voltage target; and
upon retrieving the second command, write the data associated with the first command to the first page in the first erase block at a second voltage target applied for a second amount of time, the second amount of time being greater than the first amount of time.

16. The storage device of claim 15, wherein the data associated with the first command is stored in a host device until the data associated with the first command is written at the second voltage target.

17. The storage device of claim 15, wherein the controller is further configured to:
write a first completion entry corresponding to the first command after writing the data associated with the first command to the first page;
retrieve a third command to write data to a third page in the first erase block after writing the first completion entry corresponding to the first write command; and
partially write the data associated with the third command to the third page in the first erase block at the first voltage target.

18. The storage device of claim 17, wherein the controller is further configured to:
upon retrieving the third command, write the data associated with the second command to the second page in the first erase block at the second voltage target; and
signal a completion of the second command.

19. The storage device of claim 18, wherein the data associated with the second command is stored in a host device until the data associated with the second command is written at the second voltage target.

20. The storage device of claim 18, wherein the controller is further configured to:
retrieve a fourth command to write data to a fourth page in the first erase block after writing the second completion entry corresponding to the second write command;
partially write the data associated with the fourth command to the fourth page in the first erase block at the first voltage target;
upon retrieving the fourth command, write the data associated with the third command to the third page in the first erase block at the second voltage target; and
signal a completion of the second command.
